(19) United States
(12) Patent Application Publication
(10) Pub. No.: US 2025/0385812 A1
(43) Pub. Date: Dec. 18, 2025

(54) ACCESS CONTROL

(71) Applicant: TENCENT TECHNOLOGY (SHENZHEN) COMPANY LIMITED, Shenzhen (CN)

(72) Inventor: Guoxu LIU, Shenzhen (CN)

(73) Assignee: TENCENT TECHNOLOGY (SHENZHEN) COMPANY LIMITED, Shenzhen (CN)

(21) Appl. No.: 19/303,946

(22) Filed: Aug. 19, 2025

Related U.S. Application Data
(63) Continuation of application No. PCT/CN2024/100535, filed on Jun. 21, 2024.

(30) Foreign Application Priority Data
Jun. 29, 2023 (CN) 202310793815.9

(51) Int. Cl. H04L 12/46; H04W 48/18

(52) U.S. Cl. CPC H04L 12/4633; H04W 48/18

(57) ABSTRACT

According to a method for access control, device information of an access device and private network information of a private network to be accessed by the access device are acquired. A tunnel creation instruction is transmitted to an access gateway of the private network according to the private network information, the tunnel creation instruction instructs the access gateway to establish a transmission tunnel with the access device. Configuration information for instructing the access device to establish the transmission tunnel with the access gateway is generated. The configuration information is transmitted to the access device in response to a detection that the access device goes online, the configuration information causes the access device to establish the transmission tunnel with the access gateway, and causes the access device to access the private network based on the transmission tunnel. Apparatus and non-transitory computer-readable storage medium counterpart embodiments are also contemplated.

### RELATED APPLICATIONS

The present application is a continuation of International Application No. PCT/CN2024/100535, filed on Jun. 21, 2024, which claims priority to Chinese Patent Application No. 202310793815.9, filed on Jun. 29, 2023. The entire disclosures of the prior applications are hereby incorporated by reference.

### FIELD OF THE TECHNOLOGY

This disclosure relates to the field of computer and communication technologies, including an access control method and apparatus, a computer-readable medium, and an electronic device.

### BACKGROUND OF THE DISCLOSURE

A virtual private cloud (VPC) is an isolated and private virtual network environment applied by a cloud user in the cloud. The VPC performs logical isolation on resources over a subnetwork to provide a user with an isolated network environment and a flexibly definable subnetwork segment, and supports adding a new defined network segment to an existing VPC at any time, to ensure that an Internet protocol (IP) address is incompletely extracted, and resolve a limitation of a node quantity brought by a subnetwork. In addition, a cloud user may smoothly migrate a service to a cloud after connecting a local data center in a manner such as a virtual private network (VPN).

### SUMMARY

Embodiments of this disclosure provide an access control method and apparatus, a computer-readable medium, and an electronic device, to reduce reliance on dedicated line networks when accessing private networks and effectively improve a network access speed.

Some aspects of the disclosure provide a method for access control. In some examples, device information of an access device and private network information of a private network to be accessed by the access device are acquired. A tunnel creation instruction is transmitted to an access gateway of the private network according to the private network information, the tunnel creation instruction instructs the access gateway to establish a transmission tunnel with the access device. Configuration information for instructing the access device to establish the transmission tunnel with the access gateway is generated. The configuration information is transmitted to the access device in response to a detection that the access device goes online, the configuration information causes the access device to establish the transmission tunnel with the access gateway, and causes the access device to access the private network based on the transmission tunnel.

Some aspects of the disclosure provide an apparatus that includes processing circuitry configured to perform the method for access control.

Some aspects of the disclosure also provide a non-transitory computer-readable storage medium storing instructions which when executed by at least one processor cause the at least one processor to perform the method for access control.

The embodiments of this disclosure provide an access control method, which includes: acquiring device information of an access device, and acquiring information about a private network to be accessed by the access device; transmitting a tunnel creation instruction to an access gateway corresponding to the private network according to the information about the private network, to instruct the access gateway to establish a transmission tunnel with the access device; generating configuration information for the access device, the configuration information being configured for instructing the access device to establish the transmission tunnel with the access gateway; and transmitting the configuration information to the access device in response to detecting that the access device goes online, establishing, by the access device, the transmission tunnel with the access gateway according to the configuration information, and accessing the private network based on the established transmission tunnel.

The embodiments of this disclosure further provide an access control apparatus, which includes: an acquisition unit, configured to acquire device information of an access device, and acquire information about a private network to be accessed by the access device; a transmission unit, configured to transmit a tunnel creation instruction to an access gateway corresponding to the private network according to the information about the private network, to instruct the access gateway to establish a transmission tunnel with the access device; a generation unit, configured to generate configuration information for the access device, the configuration information being configured for instructing the access device to establish the transmission tunnel with the access gateway; and a processing unit, configured to transmit the configuration information to the access device in response to detecting that the access device goes online, establish the transmission tunnel through the access device with the access gateway according to the configuration information, and access the private network based on the established transmission tunnel.

The embodiments of this disclosure further provide a computer-readable medium (e.g., non-transitory computer-readable storage medium), which has a computer program stored therein. A processor (an example of processing circuitry) executes the computer program, to implement the access control method according to the foregoing embodiments.

The embodiments of this disclosure further provide an electronic device, which includes: one or more processors; and a memory, configured to store one or more programs, the one or more processors executing the one or more programs, to cause the electronic device to implement the access control method according to the foregoing embodiments.

The embodiments of this disclosure further provide a computer program product, which includes a computer program. The computer program is stored in a computer-readable storage medium. A processor of an electronic device reads the computer program from the computer-readable storage medium and executes the computer program, to cause the electronic device to perform the access control method according to the foregoing embodiments.

The foregoing general descriptions and the following detailed descriptions are for illustration and explanation purposes and are not intended to limit this disclosure.

### BRIEF DESCRIPTION OF THE DRAWINGS

FIG. 1 is a schematic diagram of an exemplary system architecture to which technical solutions in embodiments of this disclosure may be applied.

FIG. 2 is a flowchart of an access control method according to an embodiment of this disclosure.

FIG. 3 is a schematic diagram of an exemplary system architecture to which access control technical solutions in embodiments of this disclosure may be applied.

FIG. 4 is a schematic diagram of an exemplary system architecture to which access control technical solutions in embodiments of this disclosure may be applied.

FIG. 5 is a schematic diagram of a connection relationship between customer premises equipment (CPE) and an access gateway according to an embodiment of this disclosure.

FIG. 6 is a schematic diagram of an exemplary system architecture to which access control technical solutions in embodiments of this disclosure may be applied.

FIG. 7 is a schematic diagram of an access relationship between a User Plane Function (UPF) and an access gateway according to an embodiment of this disclosure.

FIG. 8 is a schematic diagram of a connection relationship between an access gateway and a dedicated line gateway method according to an embodiment of this disclosure.

FIG. 9 is an interaction flowchart of an access control method according to an embodiment of this disclosure.

FIG. 10 is a schematic diagram of a cloud network controller processing according to a heartbeat message according to an embodiment of this disclosure.

FIG. 11 is an interaction flowchart of an access control method according to an embodiment of this disclosure.

FIG. 12 is a block diagram of an access control apparatus according to an embodiment of this disclosure.

FIG. 13 is a schematic structural diagram of a computer system adapted to implement an electronic device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

In addition, the features, structures, or characteristics described in this disclosure may be combined in one or more embodiments in any appropriate manner. The following description has many specific details, whereby the embodiments of this disclosure may be fully understood. However, it is noted that, technical solutions of this disclosure may be implemented without using all detailed features in the embodiments, one or more particular details may be omitted, or other methods, elements, apparatuses, or operations may be used.

The block diagrams shown in the accompanying drawings are merely functional entities and do not necessarily correspond to physically independent entities. That is, the functional entities may be implemented in a software form, or in one or more hardware modules or integrated circuits, or in different networks and/or processor apparatuses and/or microcontroller apparatuses.

The flowcharts shown in the accompanying drawings are merely exemplary descriptions, do not need to include all content and operations/steps, and do not need to be performed in the described orders either. For example, some operations/steps may be further divided, while some operations/steps may be combined or partially combined. Therefore, an actual execution order may change according to an actual case.

In addition, “plurality of” herein means two or more. The term “and/or” is used for describing an association relationship between associated objects and representing that three relationships may exist. For example, A and/or B may represent the following three cases: only A exists, both A and B exist, and only B exists. The character “/” generally indicates an “or” relationship between the associated objects.

The technical solutions in the embodiments of this disclosure relate to the field of could technology. The cloud technology refers to a hosting technology that unifies a series of resources, such as hardware, software, and a network, in a wide area network or a local area network, to implement computation, storage, processing, and sharing of data.

The cloud technology is a general term of network technologies, information technologies, integration technologies, management platform technologies, application technologies, and the like applied to a cloud computing business model, and may form a resource pool to satisfy what is needed in a flexible and convenient manner. A backend service of a cloud technology network system needs a large number of computation and storage resources, such as a video website, a picture website, and more portal websites. With rapid development and application of the Internet industry, each item may have its own identifier in the future, and the identifiers need to be transmitted to a backend system for logical processing. Data of different levels is processed separately, and all kinds of industry data require a strong system support, which can be achieved only through cloud computing.

In some implementation methods, if a cloud user needs to connect a local Internet data center (IDC) or a network device with a virtual private cloud (VPC, also referred to as a private network) in the cloud, and enjoy low latency, high bandwidth, and secure network quality, the cloud user can only access a nearest point-of-presence (POP) of a local operator by opening a dedicated line through the operator, and then connect to the cloud VPC through the operator's dedicated line. This method is not only costly, but the time it takes to open the dedicated line is also affected by the operator's construction. It is also very inconvenient for users who move frequently or require multi-location deployment.

The embodiments of this disclosure provide a novel network access control solution. A control device (“controller” for short) delivers a tunnel creation instruction and configuration information to implement access of a network access party to a private network, which reduces reliance on dedicated line networks when accessing private networks. In addition, after going online, an access device may automatically access the private network according to the configuration information, which effectively improves a network access speed.

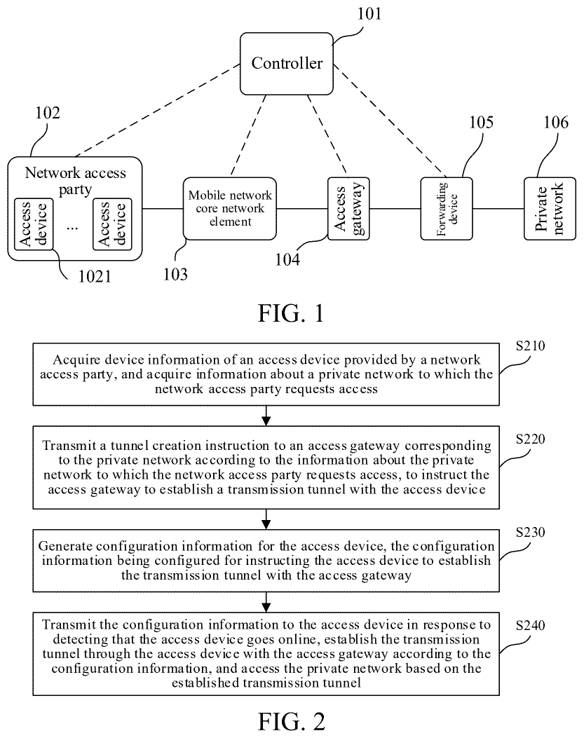

In some examples, in a specific application scenario of this disclosure, as shown in FIG. 1, a system architecture includes a controller 101, a network access party 102, a mobile network core network element 103, a private network 106, and an access gateway (GW) 104 and a forwarding device 105 that correspond to the private network 106. At least one access device 1021 is deployed in the network access party 102.

In some embodiments, the controller 101 may be a server. The server may be an independent physical server, or may be a server cluster or distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The access device 1021 may be local customer premises equipment (CPE), a terminal device capable of accessing a network, or the like. The terminal device may be, for example, but is not limited to, a smartphone, a tablet computer, a notebook computer, a desktop computer, a smart speaker, a smartwatch, an on-board terminal, or an aircraft.

In some embodiments of this disclosure, the controller 101 may acquire device information of the access device 1021 that is provided by the network access party 102, and acquire information about a private network to which the network access party 102 requests access (that is, a private network to be accessed by the access device 1021). The device information of the access device 1021 may be, for example, a unique identifier of the device, a network address of the device, or port information of the device. The information about the private network may be, for example, identification information, network address information, and port information of the private network.

In some embodiments of this disclosure, after acquiring the information about the private network to which the network access party 102 requests access, the controller 101 transmits a tunnel creation instruction to the access gateway 104 corresponding to the private network according to the information about the private network, to instruct the access gateway 104 to establish a transmission tunnel with the access device 1021. Meanwhile, the controller 101 may generate configuration information for the access device 1021. The configuration information is configured for instructing the access device 1021 to establish the transmission tunnel with the access gateway 104. Further, after detecting that the access device 1021 goes online, the controller 101 may transmit the configuration information to the access device 1021, and the access device 1021 establishes the transmission tunnel with the access gateway 104 according to the configuration information, and accesses the private network based on the established transmission tunnel.

In some embodiments, because the transmission tunnel between the access device 1021 and the access gateway 104 is established through the mobile network core network element 103, the controller 101 may transmit a Generic Routing Encapsulation (GRE) tunnel establishment instruction to the access gateway 104 and the core network element 103, to instruct the core network element 103 to establish a GRE tunnel with the access gateway 104. The transmission tunnel established between the access device 1021 and the access gateway 104 may be carried over the GRE tunnel.

In some embodiments, the controller 101 may further transmit a tunnel creation instruction to the access gateway 104 and the forwarding device 105 connected between the access gateway 104 and the private network, to instruct the access gateway 104 to establish a transmission tunnel with the forwarding device 105. The transmission tunnel between the access gateway 104 and the forwarding device 105 is configured to transmit traffic of the access device 1021 to the forwarding device 105, and the forwarding device 105 routes the traffic of the access device 1021 to the private network.

In some embodiments, to ensure data security, the transmission tunnel established between the access device 1021 and the access gateway 104 may be an Internet Protocol Security (IPSec) tunnel. In some embodiments, because the access gateway 104 and the forwarding device 105 may be deployed inside a network provider, encrypted transmission is not required. Therefore, the IPSec tunnel may be decapsulated on the access gateway 104, and user traffic is then forwarded to a more lightweight Virtual Extensible Local Area Network (VXLAN) tunnel. That is, the transmission tunnel between the access gateway 104 and the forwarding device 105 may be the VXLAN tunnel.

In some embodiments, the core network element 103 may be a User Plane Function (UPF). The UPF is an important constituent part of a system architecture of a 3GPP 5G core network, and is mainly responsible for functions related to routing and forwarding of a user plane data packet in the 5G core network. The forwarding device 105 may be a Next Generation GateWay (NGW), which is mainly used in scenarios such as hybrid cloud dedicated line access, inter-domain interconnection, and public cloud interconnection. It achieves high-performance forwarding, supports multi-tenant access, supports Tunnel-GRE (TGRE) and VXLAN tunneling protocols, and supports characteristics such as fragmentation, reorganization, and rate limiting.

In the system architecture shown in FIG. 1, the access device may access the private network by delivering the tunnel creation instruction and the configuration information by the controller 101, which reduces reliance on dedicated line networks when accessing private networks. In addition, after going online, the access device may automatically access the private network according to the configuration information, which effectively improves a network access speed.

The implementation details of the technical solutions in the embodiments of this disclosure are described in detail below.

FIG. 2 is a flowchart of an access control method according to an embodiment of this disclosure. The access control method may be performed by a controller, which may be the controller 101 shown in FIG. 1. As shown in FIG. 2, the access control method includes at least operation S210 to operation S230. A detailed description is as follows:

S210: Acquire device information of an access device provided by a network access party, and acquire information about a private network to which the network access party requests access.

In some embodiments, the network access party may transmit, to the controller through a configuration interface, a console, or the like, the device information of the access device and the information about the private network to which access is requested. The network access party may be a tenant of the private network, and the access device may be CPE, a terminal device capable of accessing a network, or the like. The device information of the access device 1021 may be, for example, a unique identifier of the device, a network address of the device, or port information of the device. The information about the private network may be, for example, identification information, network address information, and port information of the private network.

S220: Transmit a tunnel creation instruction to an access gateway corresponding to the private network according to the information about the private network to which the network access party requests access, to instruct the access gateway to establish a transmission tunnel with the access device.

In some embodiments, the transmission tunnel between the access gateway and the access device may be an IPSec tunnel. Therefore, data security can be ensured during transmission of data of the access device to the access gateway. In this case, the controller may acquire a tunnel encryption key provided by the network access party for the access device, and then add the tunnel encryption key to the tunnel creation instruction, and the access device establishes an encrypted transmission tunnel with the access network gateway based on the tunnel encryption key.

In some embodiments, the process in which the controller transmits the tunnel creation instruction to the access gateway corresponding to the private network may include the following sequentially performed processes: the controller transmits Virtual Routing and Forwarding (VRF) creation information to the access gateway, transmits an IPSec tunnel creation information to the access gateway, transmits interface Internet protocol (IP) creation information to the access gateway, configures Internet Key Exchange (IKE, a hybrid encryption protocol) encryption information to the access gateway, configures Border Gateway Protocol (BGP) information to the access gateway, and the like.

S230: Generate configuration information for the access device, the configuration information being configured for instructing the access device to establish the transmission tunnel with the access gateway.

In some embodiments, the configuration information for the access device may include: IPSec tunnel creation information, interface IP creation information, and configured IKE encryption information. After generating the configuration information for the access device, the controller may store the configuration information into a database.

In addition, a sequence of performing S220 and S230 shown in FIG. 2 is not limited. For example, S220 and then S230 may be performed according to the sequence shown in FIG. 2. Alternatively, S230 may be performed first and then S220 is performed. Alternatively, S220 and S230 may be performed at the same time.

S240: Transmit the configuration information to the access device in response to detecting that the access device goes online, establish the transmission tunnel through the access device with the access gateway according to the configuration information, and access the private network based on the established transmission tunnel.

In some embodiments, the access device may periodically transmit a heartbeat message to the controller after going online. The controller may determine, when receiving the heartbeat message transmitted by the access device, that the access device is detected to be online. In this way, after the access device goes online, the controller may directly transmit the configuration information to the access device, and the access device may automatically establish the transmission tunnel with the access gateway. In addition, after receiving the configuration information, the access device may further locally store the configuration information.

In some embodiments, the heartbeat message periodically transmitted after the access device goes online may further include a last boot time of the access device. The controller may acquire the last boot time of the access device from the heartbeat message transmitted by the access device, or may acquire a last boot time recorded for the access device from the database. If the last boot time included in the heartbeat message is inconsistent with the last boot time recorded in the database, it indicates that the access device has been restarted, and current configuration information stored in the access device may be acquired. Configuration information stored in the database may be transmitted to the access device in response to the current configuration information of the access device not matching the configuration information stored in the database for the access device. According to the technical solution in this embodiment, after the access device is restarted or in a case that the locally stored configuration information is lost, the controller may deliver the configuration information stored in the database for the access device to the access device in time, to ensure that the access device can acquire latest configuration information and establish the transmission tunnel with the access gateway based on the latest configuration information.

In some embodiments, the process in which the controller transmits the configuration information stored in the database for the access device to the access device may include follows: the controller searches the configuration information stored in the database for the access device for configuration information different from the current configuration information, and then transmits the found configuration information different from the current configuration information to the access device. According to the technical solution in this embodiment, only differential configuration information may be transmitted to the access device. Compared with transmitting complete configuration information to the access device, transmitting the differential configuration information may reduce bandwidth occupied by transmitting the configuration information and transmission time, to ensure that the access device can acquire the latest configuration information as soon as possible.

In some embodiments, after transmitting the differential configuration information to the access device, the controller may update, according to the last boot time included in the heartbeat message, the last boot time recorded in the database for the access device, to subsequently determine, according to the updated last boot time in the database, whether the access device is restarted.

In some embodiments, the private network may correspond to at least two access gateways, and the controller may transmit the configuration information to the access device, to instruct the access device to establish transmission tunnels with the at least two access gateways respectively, and instruct the access device to configure the transmission tunnels established between the access device and the at least two access gateways as an equal-cost multi-path routing (ECMP) manner. In this way, when any access gateway fails, service traffic can be seamlessly relayed by using another access gateway, to ensure continuity and stability of service traffic transmission.

In some embodiments, the transmission tunnel between the access device and the access network element may be established by the access device with the access gateway through a core network element. In this case, the controller may transmit a GRE tunnel establishment instruction to the access gateway and the core network element, to instruct the core network element to establish a GRE tunnel with the access gateway. In this case, the transmission tunnel between the access device and the access gateway may be carried over the GRE tunnel. For example, if the transmission tunnel between the access device and the access gateway is an IPSec tunnel, in the transmission tunnel established between the access device and the access gateway, the transmission tunnel between the core network element and the access gateway is an IPSec over GRE tunnel.

In some embodiments, the private network may correspond to at least two access gateways. In this case, the controller may transmit a GRE tunnel establishment instruction to the at least two access gateways and at least two core network elements, to instruct each core network element to establish GRE tunnels with the at least two access gateways respectively, and instruct each core network element to configure the GRE tunnels established between the core network element and the at least two access gateways as an ECMP manner. According to the technical solution in this embodiment, a forwarding capability between the access gateway and the core network element may be efficiently utilized, and reliability and stability of network transmission may be ensured through ECMP when some core network elements or some access gateways are abnormal.

In some embodiments, a forwarding device may be connected between the access gateway and the private network. The forwarding device may be a gateway device. For example, the forwarding device may be an NGW device. The forwarding device may forward user traffic to the private network after receiving the user traffic forwarded by the access gateway.

In some embodiments, the controller may transmit a tunnel creation instruction to the access gateway and the forwarding device connected between the access gateway and the private network, to instruct the access gateway to establish a transmission tunnel with the forwarding device. The transmission tunnel between the access gateway and the forwarding device is configured to transmit traffic of the access device to the forwarding device, and the forwarding device routes the traffic of the access device to the private network.

In some embodiments, the private network may correspond to at least two access gateways and at least two forwarding devices, and the controller may transmit a tunnel creation instruction to the at least two access gateways and the at least two forwarding devices, to instruct each access gateway to establish a transmission tunnel with the at least two forwarding devices respectively, and instruct each access gateway to configure the transmission tunnels established between the access gateway and the at least two forwarding devices as an ECMP manner. According to the technical solution in this embodiment, a forwarding capability between the access gateway and the forwarding device may be efficiently utilized, and reliability and stability of network transmission may be ensured through ECMP when some forwarding devices or some access gateways are abnormal.

In some embodiments, because the access gateway and the forwarding device are located inside a network provider, encrypted transmission is not required. Therefore, the transmission tunnel between the access gateway and the forwarding device may be a lightweight VXLAN tunnel. If the transmission tunnel between the access device and the access gateway is an IPSec tunnel, the access gateway may decapsulate the IPSec tunnel, and then transfer the user traffic to the VXLAN tunnel, the user traffic is further routed to the forwarding device, and the forwarding device transmits the user traffic to the private network.

According to the technical solution in the foregoing embodiments of this disclosure, the tunnel creation instruction is transmitted to the access gateway corresponding to the private network according to the information about the private network to be accessed by the access device, to instruct the access gateway to establish the transmission tunnel with the access device. In addition, the configuration information is generated for the access device. After it is detected that the access device goes online, the configuration information is transmitted to the access device, and the access device establishes the transmission tunnel with the access gateway according to the configuration information, and accesses the private network based on the established transmission tunnel. In this way, access of the access device to the private network may be implemented by delivering the tunnel creation instruction and the configuration information (through the controller), which reduces reliance on dedicated line networks when accessing private networks. In addition, after going online, the access device may automatically access the private network according to the configuration information, which effectively improves a network access speed.

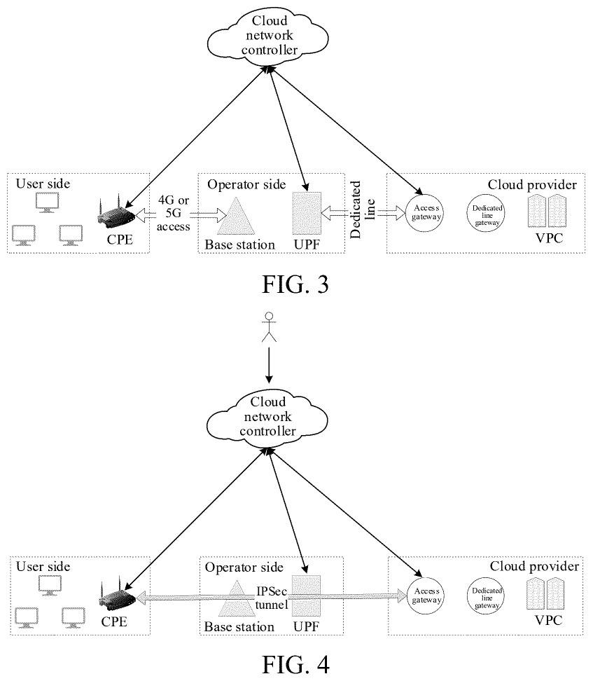

The network access solution in the embodiments of this disclosure will be described in detail below with reference to FIG. 3 to FIG. 11 and specific application scenarios.

In an application scenario shown in FIG. 3, a cloud network controller is configured to implement the functions of the controller in the foregoing embodiments. A user side may be a user who rents a private network VPC, namely, a network access party in the foregoing embodiment, a UPF is the core network element in the foregoing embodiments, and a dedicated line gateway is the forwarding device in the foregoing embodiments. The technical solution in the embodiment shown in FIG. 3 mainly adopts a design idea of control and user plane separation in Network Functions Virtualization (NFV), and is divided into a cloud network controller deployed on the cloud and a lower-layer network device. The cloud network controller is responsible for device management and control, configuration delivery, status detection, and the like. The network device includes mobile CPE on the user side that is configured to access a network; a base station, a UPF, and the like on an operator side; and an access gateway and a dedicated line gateway, and the like on a cloud provider side.

Based on the application scenario shown in FIG. 3, when the CPE on the user side accesses a network, the user side may connect the CPE (or a private IDC behind the CPE) of the user side to a network nearest to the user side, such as a mobile network, and a 4G or 5G network. The UPF on the operator side and the access gateway on the cloud provider side may be connected via a dedicated line.

Because an air interface network is carried over a public network, user data encryption is required. Therefore, as shown in FIG. 4, an IPSec tunnel may be established between the CPE of the user and the access gateway, and an encrypted tunnel directly traverses the network of the operator to the access gateway, making public network and internal network link of the operator unaware of the existence of the tunnel. In this way, security of the user data is maximized.

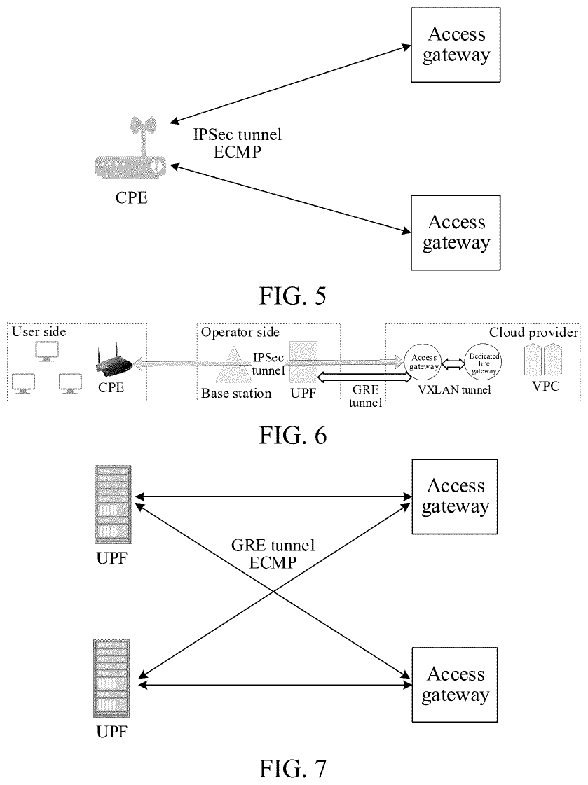

In some embodiments, in a network of a cloud provider, for network reliability, two (or more) dual-active access gateways may be deployed. The two access gateways work simultaneously, each carrying a portion of network traffic. When either one fails, the other one may take over all service traffic without switching. As shown in FIG. 5, the CPE of the user may establish IPSec tunnels with both of the two gateways, and ECMP is configured on the CPE to enable equal-cost routing for the two IPSec tunnels. The processes of tunnel establishment and faulty link switching are both automatically completed by the network device, which is completely not perceived by the user, and can provide a good experience for the user.

In some embodiments, as shown in FIG. 6, in a connection between networks of a cloud provider and an operator, the operator usually provides a general GRE tunnel for network encapsulation, to distinguish different users of the operator. One end of the GRE tunnel is a UPF of the operator, and the other end is an access gateway of a cloud manufacturer. The GRE tunnel is configured to carry an IPSec tunnel established by CPE of a user. In this case, a GRE tunnel of an underlay network is invisible to the user, and the IPSec tunnel established by the CPE of the user is automatically carried over the GRE tunnel when the IPSec tunnel traverses the UPF, that is, accesses a gateway on a cloud in the form of IPSec over GRE.

In some embodiments, as shown in FIG. 7, an operator usually provides two or more UPFs (a description is made below by taking two UPFs as an example) for access. In this case, full mesh GRE tunnels may be established between the two UPFs and two access gateways through a cloud network controller, and the two tunnels on respective devices are ECMP. In this way, a forwarding capability of a network device may be efficiently utilized, and high reliability and stability of a network can also be ensured in an abnormal case. For example, if one UPF is unavailable, due to characteristics of ECMP scheduling, traffic is forwarded by the other UPF. When the abnormal device is restored to being online, distribution of the traffic will be automatically restored. Similarly, for the access gateways, traffic of a user remains unaffected as long as at least one UPF and at least one access gateway are available in the network, which enhances link quality and service continuity.

In some embodiments, after user traffic reaches the access gateway, the user traffic needs to reach a VPC through a dedicated line gateway. A VXLAN tunnel may be adopted between the access gateway and the dedicated line gateway. The VXLAN has a VXLAN network identifier (VNI) of 24 bits and can support up to 16 million user access, which is far larger than 12 bits of a virtual local area network (VLAN). Therefore, the VXLAN tunnel is very suitable for a cloud provider to divide tenants during access. In addition, because the network traffic already enters the cloud provider, encrypted transmission is not required. Therefore, an IPSec tunnel may be decapsulated on the access gateway, to transfer the user traffic to a more lightweight VXLAN tunnel.

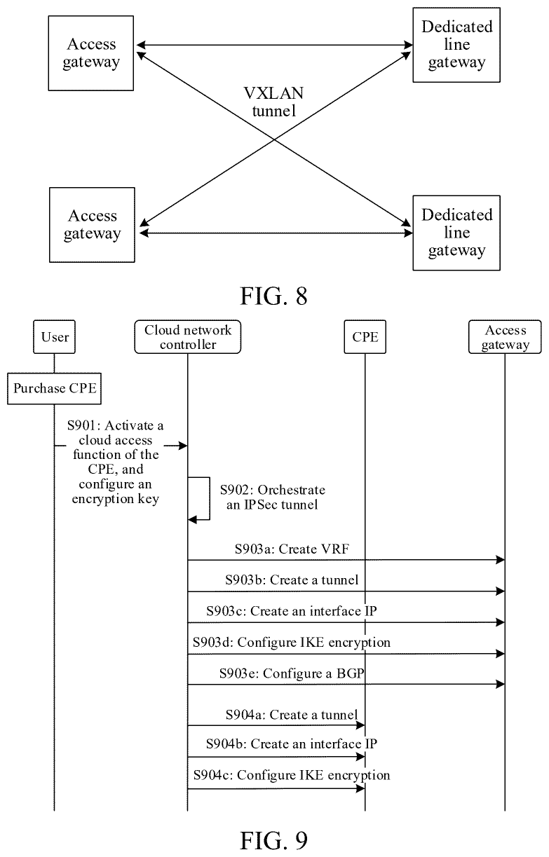

In some embodiments, as shown in FIG. 8, a cloud provider may provide two or more access gateways and two or more dedicated line gateways (a description is made below by taking two access gateways and two dedicated line gateways as an example) for access. In this case, VXLAN tunnels may be established between the two access gateways and the two private line gateways through a cloud network controller, and the two tunnels on respective devices are ECMP. In this way, a forwarding capability of a network device may be efficiently utilized, and high reliability and stability of a network can also be ensured in an abnormal case.

In some embodiments of this disclosure, when a user purchases CPE, a tunnel can be configured through a cloud network controller to connect the CPE to a cloud provider, and then the cloud network controller orchestrates a network tunnel instruction and configures the network tunnel instruction to devices at two ends. In this way, the CPE may complete access. As shown in FIG. 9, the following operations are included:

S901: After purchasing CPE, a user activates a cloud access function of the CPE through a cloud network controller and configures an encryption key.

S902: The cloud network controller starts to orchestrate an IPSec tunnel accessed by the CPE, and then prepares to transmit a tunnel creation instruction to the CPE and an access gateway.

Then, the cloud network controller performs S903a to S903e, that is, sequentially transmits VRF creation information, IPSec tunnel creation information, interface IP creation information, IKE encryption configuration information, BGP configuration information, and the like to the access gateway. Then, the cloud network controller performs S904a to S904c, that is, sequentially transmits the IPSec tunnel creation information, the interface IP creation information, and the IKE encryption configuration information to the CPE.

After configuration for both the CPE and the access gateway is completed, the CPE may automatically access the access gateway, to connect a local IDC with a VPC network on the cloud.

In some embodiments of this disclosure, because the CPE of the user is in its own network environment, unlike the access gateways deployed as servers, the instruction orchestrated by the cloud network controller may not be transmitted to the CPE at any time (for example, the CPE is powered off). After configuration through the cloud network controller, the user expects that the CPE can automatically access the private network upon the CPE going online. This requires that the cloud network controller can provide functions of detecting a status of the CPE and redelivering the configuration.

In an embodiment, one record may be stored in a database table of the cloud network controller for each CPE. As shown in Table 1, identifier information and configuration information of the CPE may be recorded, and in addition, a last boot time of the CPE may be stored. After going online, the CPE may periodically report heartbeat information to the cloud network controller, and a message body carries a last boot time of the CPE.

TABLE 1

| CPE_ID | CONFIG | |
|---|---|---|
| (identification | (configuration | LAST_BOOT_TIME |
| information of CPE) | information) | (latest boot time) |
| CPE001 | CONFIG_VALUE | Apr. 1, 2023 12:00:00 PM |

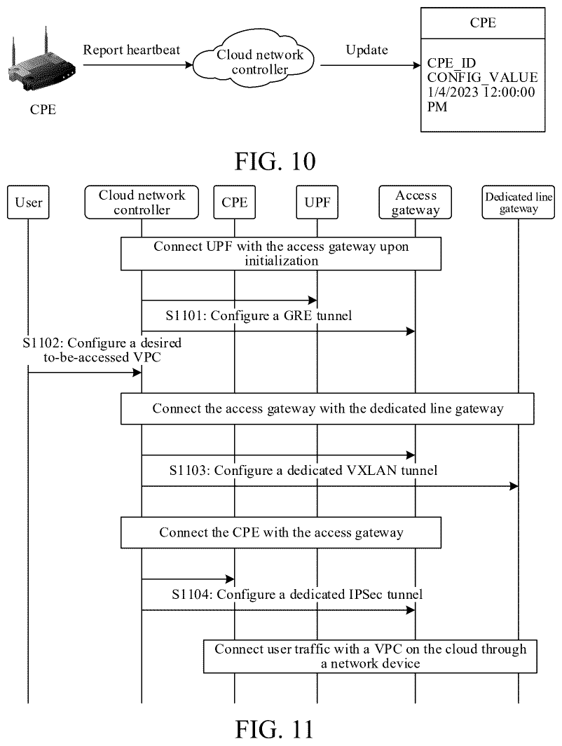

When receiving a heartbeat message reported by the CPE, the cloud network controller checks whether a last boot time in the heartbeat message is consistent with the last boot time stored in the database. If there is an update, it indicates that the CPE has been restarted. There may be new configuration information during restart of the CPE, or locally stored configuration information may be lost due to a failure of the CPE. Therefore, the cloud network controller performs configuration check on the CPE when determining that the CPE has been restarted. For example, the cloud network controller may acquire current configuration information of the CPE through a management interface of the CPE, then compare the current configuration information with the configuration information in the database, and deliver differential configuration information to the CPE. In this way, for a newly purchased device, after the user performs initial configuration through the cloud network controller, the cloud network controller supplements configuration information for the CPE when the CPE is powered on and automatically connected, and then the CPE automatically establishes an encrypted tunnel with a private network of a cloud provider. This process is not perceived by the user. During use of the CPE, in a case of power-off, restart or accidental downtime at any time, the cloud network controller automatically checks and repairs configuration information of the CPE. In addition, the cloud network controller needs to update the last boot time stored in the database in time. As shown in FIG. 10, a CPE periodically reports a heartbeat message to a cloud network controller, and then the cloud network controller updates, according to the heartbeat message, information stored in a database, such as the last boot time.

Based on the foregoing system architecture and related configuration, the idea of control and user plane separation is adopted in the embodiments of this disclosure. That is, various types of configuration information are orchestrated and delivered by the cloud network controller, and an underlying network device is service-agnostic, and only needs to provide a standard control interface to configure a network according to the instruction orchestrated by the cloud network controller. An exemplary processing flowchart is shown in FIG. 11, and includes the following operations:

S1101: A cloud network controller transmits configuration information to a UPF and an access gateway during initialization. In some examples, a UPF of an operator is connected with an access gateway of a cloud provider through the cloud network controller, that is, establishes a GRE tunnel between the UPF and the access gateway.

S1102: When the user needs to use a private network, the user configures, for the cloud network controller through a cloud console, a VPC network that CPE of the user wants to access.

S1103: The controller delivers configuration information to an access gateway and a dedicated line gateway, to configure a VXLAN tunnel between the access gateway and the dedicated line gateway, to connect the access gateway with the dedicated line gateway.

S1104: The controller allocates a dedicated IPSec tunnel resource for the user, and allocates and configures the dedicated IPSec tunnel resource to the CPE and the access gateway, to connect the CPE with the access gateway.

After the foregoing configuration is completed, the user may access the VPC on the cloud through the CPE in a mobile network manner.

It can be seen that, in the embodiments of this disclosure, the CPE of the user can access the VPC quickly and efficiently, which takes full advantage of characteristics of low latency and high bandwidth of 4G/5G networks, and replaces reliance on dedicated lines when accessing private gateways in some implementation methods. In addition, through the cloud network controller, the user only needs to perform simple configuration to allow the CPE to automatically access the private network. In scenarios such as offline and abnormal downtime of the device, the cloud network controller can also automatically restore the configuration for the device. A full mesh network tunnel is constructed through a plurality of cloud network devices in mutual active-standby mode, to provide reliable connectivity services that match the quality of dedicated line connection for users.

The following describes embodiments of an apparatus of this disclosure, and the apparatus may be configured to perform the access control method in the foregoing embodiments of this disclosure. For details not disclosed in the embodiments of the apparatus of this disclosure, refer to the foregoing embodiments of the access control method of this disclosure.

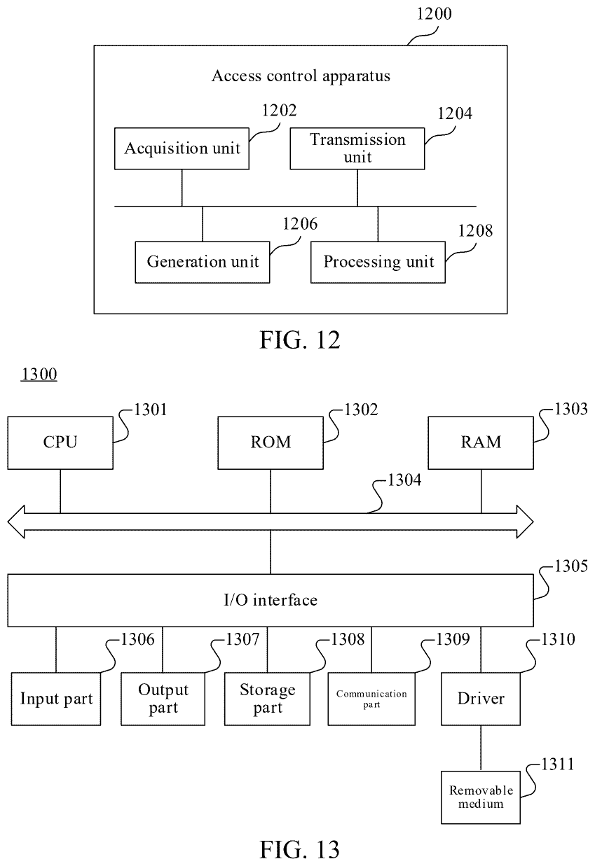

FIG. 12 is a block diagram of an access control apparatus according to some embodiments of this disclosure. The access control apparatus may be deployed in a controller.

As shown in FIG. 12, an access control apparatus 1200 according to some embodiments of this disclosure includes: an acquisition unit 1202, a transmission unit 1204, a generation unit 1206, and a processing unit 1208.

The acquisition unit 1202 is configured to acquire device information of an access device, and acquire information about a private network to be accessed by the access device. The transmission unit 1204 is configured to transmit a tunnel creation instruction to an access gateway corresponding to the private network according to the information about the private network, to instruct the access gateway to establish a transmission tunnel with the access device. The generation unit 1206 is configured to generate configuration information for the access device, the configuration information being configured for instructing the access device to establish the transmission tunnel with the access gateway. The processing unit 1208 is configured to transmit the configuration information to the access device in response to detecting that the access device goes online, establish the transmission tunnel through the access device with the access gateway according to the configuration information, and access the private network based on the established transmission tunnel.

In some embodiments of this disclosure, based on the foregoing solutions, the access control apparatus 1200 further includes a receiving unit, configured to receive a heartbeat message periodically transmitted after the access device goes online, the heartbeat message including a last boot time of the access device. The acquisition unit 1202 is further configured to: acquire a last boot time recorded for the access device from a database; and acquire current configuration information in the access device if the last boot time included in the heartbeat message is inconsistent with the last boot time recorded in the database. The transmission unit 1204 is further configured to: transmit configuration information stored in the database for the access device to the access device in response to the current configuration information not matching the configuration information stored in the database for the access device.

FIG. 13 is a schematic structural diagram of a computer system adapted to implement an electronic device according to an embodiment of this disclosure. The electronic device may be the controller according to the foregoing embodiments.

In addition, a computer system 1300 for the electronic device shown in FIG. 13 is merely an example, and does not constitute any limitation on functions and use ranges of the embodiments of this disclosure.

As shown in FIG. 13, the computer system 1300 may include a central processing unit (CPU) 1301, which may perform various appropriate actions and processing according to a program stored in a read-only memory (ROM) 1302 or a program loaded from a storage part 1308 into a random-access memory (RAM) 1303, for example, perform the method according to the foregoing embodiments. The RAM 1303 further stores various programs and data required for system operations. The CPU 1301, the ROM 1302, and the RAM 1303 are connected to each other through a bus 1304. An input/output (I/O) interface 1305 is also connected to the bus 1304.

The following components may be connected to the I/O interface 1305: an input part 1306 including a keyboard, a mouse, and the like; an output part 1307 including a cathode ray tube (CRT), a liquid crystal display (LCD), a speaker, and the like; the storage part 1308 including a hard disk and the like; and a communication part 1309 including a network interface card such as a local area network (LAN) card or a modem. The communication part 1309 performs communication processing over a network such as the Internet. A driver 1310 is also connected to the I/O interface 1305 as required. A removable medium 1311, such as a magnetic disk, an optical disc, a magneto-optical disk, or a semiconductor memory, is installed on the drive 1310 as required, whereby a computer program read from the removable medium is installed into the storage part 1308 as required.

Particularly, according to the embodiments of this disclosure, the processes described above with reference to the flowcharts may be implemented as computer software programs. For example, the embodiments of this disclosure provide a computer program product, which includes a computer program carried on a computer-readable medium. The computer program is configured for performing the method shown in the flowchart. In such embodiments, the computer program may be downloaded and installed from a network through the communication part 1309, and/or installed from the removable medium 1311. The CPU 1301 executes the computer program, to perform various functions defined in the system of this disclosure.

In addition, the computer-readable medium according to the embodiments of this disclosure may be a computer-readable signal medium, a computer-readable storage medium, or any combination of the two. The computer-readable storage medium may be, for example, but is not limited to, an electric, magnetic, optical, electromagnetic, infrared, or semi-conductive system, apparatus, or component, or any combination of the above. More specific examples of the computer-readable storage medium may include, but are not limited to, an electrical connection with one or more conductors, a portable computer disk, a hard disk, an RAM, an ROM, an erasable programmable read-only memory (EPROM), a flash memory, an optical fiber, a portable compact disc read-only memory (CD-ROM), an optical storage device, a magnetic storage device, or any appropriate combination thereof. In this disclosure, the computer-readable storage medium may be any tangible medium containing or storing a computer program, and the computer program may be used by or used in combination with an instruction execution system, apparatus, or device. In this disclosure, the computer-readable signal medium may include a data signal propagated in a baseband or as part of a carrier, carrying a computer-readable computer program. A data signal propagated in such a way may assume a plurality of forms, including but not limited to, an electromagnetic signal, an optical signal, or any appropriate combination thereof. The computer-readable signal medium may further be any computer-readable medium rather than a computer-readable storage medium. The computer-readable medium may transmit, propagate, or transfer a program that is used by or used in combination with an instruction execution system, apparatus, or device. The computer program included in the computer-readable medium may be transmitted through any appropriate medium, including but not limited to, a wireless medium, a wired medium, or any appropriate combination of the above.

The flowcharts and block diagrams in the accompanying drawings illustrate some system architectures, functions, and operations that may be implemented by the system, the method, and the computer program product according to various embodiments of this disclosure. Each box in the flowchart or the block diagram may represent a module, a program segment, or a part of code. The module, the program segment, or the part of code includes one or more executable instructions configured for implementing specified logic functions. In some alternative implementations, the functions annotated in the boxes may occur in a sequence different from that annotated in the accompanying drawing. For example, actually two boxes shown in succession may be performed basically in parallel, and sometimes the two boxes may be performed in a reverse sequence. This is determined by a related function. Each box in the block diagram and/or the flowchart and a combination of boxes in the block diagram and/or the flowchart may be implemented by using a dedicated hardware-based system configured to perform a specified function or operation, or may be implemented by using a combination of dedicated hardware and a computer program.

The related unit described in the embodiments of this disclosure may be implemented in a software manner, or may be implemented in a hardware manner, or the unit described may be set in the processor. Names of the units do not constitute a limitation on the units in a specific case.

This disclosure further provides a computer-readable medium. The computer-readable medium may be included in the electronic device according to the foregoing embodiments; or may exist alone without being assembled into the electronic device. The foregoing computer-readable medium carries one or more computer programs. One electronic device executes the one or more computer programs, to cause the electronic device to implement the method according to the foregoing embodiments.

Although several modules or units of a device configured to perform actions are discussed in the foregoing detailed description, such division is not mandatory. Actually, according to the implementations of this disclosure, the features and functions of two or more modules or units described above may be embodied in one module or unit. On the contrary, the feature and function of one module or unit described above may be further divided to be embodied in a plurality of modules or units.

According to the foregoing descriptions of the implementations, it is noted that the implementations described herein may be implemented by using software, or may be implemented by software in combination with necessary hardware. Therefore, the technical solutions in the embodiments of this disclosure may be implemented in the form of software product. The software product may be stored in a non-volatile storage medium (which may be a CD-ROM, a Universal Serial Bus (USB) flash drive, a removable hard disk, or the like) or on a network, including several instructions to cause an electronic device to perform the method according to the embodiments of this disclosure.

For example, if the electronic device is a controller, the controller performs the access control method shown in FIG. 2.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method for access control, comprising:
acquiring device information of an access device, and private network information of a private network to be accessed by the access device;
transmitting a tunnel creation instruction to an access gateway of the private network according to the private network information, the tunnel creation instruction instructing the access gateway to establish a transmission tunnel with the access device;
generating configuration information for instructing the access device to establish the transmission tunnel with the access gateway; and
transmitting the configuration information to the access device in response to a detection that the access device goes online, the configuration information causing the access device to establish the transmission tunnel with the access gateway, and causing the access device to access the private network based on the transmission tunnel.

2. The method according to claim 1, further comprising:
determining that the access device is online in response to a receiving of a heartbeat message that is transmitted by the access device, the heartbeat message being periodically transmitted by the access device after the access device goes online.

3. The method according to claim 1, further comprising:
storing the configuration information into a database;
receiving a heartbeat message that is transmitted by the access device, the heartbeat message comprising a current latest boot time of the access device;
acquiring a recorded latest boot time of the access device from the database;
acquiring current configuration information in the access device when the current latest boot time in the heartbeat message is inconsistent with the recorded latest boot time in the database; and
transmitting the configuration information stored in the database to the access device when the current configuration information does not match with the configuration information stored in the database.

4. The method according to claim 3, wherein the transmitting the configuration information comprises:
searching the database for the configuration information that is different from the current configuration information; and
transmitting the configuration information that is different from the current configuration information to the access device.

5. The method according to claim 3, further comprising:
updating, the recorded latest boot time for the access device in the database according to the current latest boot time in the heartbeat message.

6. The method according to claim 1, further comprising:
acquiring a tunnel encryption key for the access device, the tunnel encryption key being provided by a network access party; and
adding the tunnel encryption key to the tunnel creation instruction and the configuration information to cause the access device to establish an encrypted transmission tunnel with the access gateway based on the tunnel encryption key.

7. The method according to claim 1, wherein the transmission tunnel is established by the access device with the access gateway through a core network element; and the method further comprises:
transmitting a Generic Routing Encapsulation (GRE) tunnel establishment instruction to the access gateway and the core network element, to instruct the core network element to establish a GRE tunnel with the access gateway, and the transmission tunnel established between the access device and the access gateway being carried over the GRE tunnel.

8. The method according to claim 7, wherein the private network comprises at least a first access gateway and a second access gateway, the transmitting the GRE tunnel establishment instruction comprises:
transmitting the GRE tunnel establishment instruction to at least the first access gateway and the second access gateway, and at least a first core network element and a second core network element, to instruct each of the first core network element and the second core network element to establish respective GRE tunnels with at least the first access gateway and the second access gateway, and instruct each of the first core network element and the second core network element to configure the respective GRE tunnels in an equal-cost multi-path routing manner.

9. The method according to claim 1, wherein the private network comprises at least a first access gateway and a second access gateway; and the transmitting the configuration information comprises:
transmitting the configuration information to the access device, to instruct the access device to establish respective transmission tunnels with at least the first access gateway and the second access gateway, and instruct the access device to configure the respective transmission tunnels in an equal-cost multi-path routing manner.

10. The method according to claim 1, further comprising:
transmitting a tunnel creation instruction to the access gateway and a forwarding device connected between the access gateway and the private network, the tunnel creation instruction instructing the access gateway to establish an intermediate transmission tunnel with the forwarding device, the intermediate transmission tunnel between the access gateway and the forwarding device transmitting traffic of the access device to the forwarding device, and the forwarding device routing the traffic of the access device to the private network.

11. The method according to claim 1, wherein the private network comprising at least a first access gateway and a second access gateway and at least a first forwarding device and a second forwarding device; and the method further comprises:
transmitting a tunnel creation instruction to at least the first access gateway and the second access gateway and at least the first forwarding device and the second forwarding device, the tunnel creation instruction instructing each of at least the first access gateway and the second access gateway to establish respective intermediate transmission tunnels with at least the first forwarding device and the second forwarding device, and instructing each of at least the first access gateway and the second access gateway to configure the respective intermediate transmission tunnels in an equal-cost multi-path routing manner.

12. The method according to claim 10, wherein the transmission tunnel comprises an Internet protocol security tunnel; and the intermediate transmission tunnel comprises a virtual extensible local area network tunnel, and the virtual extensible local area network tunnel is configured to transmit, to the forwarding device, decapsulated traffic that is obtained after the access gateway decapsulates the traffic of the access device from the Internet protocol security tunnel.

13. An apparatus for access control, comprising processing circuitry configured to:
acquire device information of an access device, and private network information of a private network to be accessed by the access device;
transmit a tunnel creation instruction to an access gateway of the private network according to the private network information, the tunnel creation instruction instructing the access gateway to establish a transmission tunnel with the access device;
generate configuration information for instructing the access device to establish the transmission tunnel with the access gateway; and
transmit the configuration information to the access device in response to a detection that the access device goes online, the configuration information causing the access device to establish the transmission tunnel with the access gateway, and causing the access device to access the private network based on the transmission tunnel.

14. The apparatus according to claim 13, wherein the processing circuitry is configured to:
determine that the access device is online in response to a receiving of a heartbeat message that is transmitted by the access device, the heartbeat message being periodically transmitted by the access device after the access device goes online.

15. The apparatus according to claim 13, wherein the processing circuitry is configured to:
store the configuration information into a database;
receive a heartbeat message that is transmitted by the access device, the heartbeat message comprising a current latest boot time of the access device;
acquire a recorded latest boot time of the access device from the database;
acquire current configuration information in the access device when the current latest boot time in the heartbeat message is inconsistent with the recorded latest boot time in the database; and
transmit the configuration information stored in the database to the access device when the current configuration information does not match with the configuration information stored in the database.

16. The apparatus according to claim 15, wherein the processing circuitry is configured to:
search the database for the configuration information that is different from the current configuration information; and
transmit the configuration information that is different from the current configuration information to the access device.

17. The apparatus according to claim 15, wherein the processing circuitry is configured to:
update, the recorded latest boot time for the access device in the database according to the current latest boot time in the heartbeat message.

18. The apparatus according to claim 13, wherein the processing circuitry is configured to:
acquire a tunnel encryption key for the access device, the tunnel encryption key being provided by a network access party; and
add the tunnel encryption key to the tunnel creation instruction and the configuration information to cause the access device to establish an encrypted transmission tunnel with the access gateway based on the tunnel encryption key.

19. The apparatus according to claim 13, wherein the transmission tunnel is established by the access device with the access gateway through a core network element; wherein the processing circuitry is configured to:
transmit a Generic Routing Encapsulation (GRE) tunnel establishment instruction to the access gateway and the core network element, to instruct the core network element to establish a GRE tunnel with the access gateway, and the transmission tunnel established between the access device and the access gateway being carried over the GRE tunnel.

20. A non-transitory computer-readable storage medium storing instructions which when executed by at least one processor cause the at least one processor to perform:
acquiring device information of an access device, and private network information of a private network to be accessed by the access device;
transmitting a tunnel creation instruction to an access gateway of the private network according to the private network information, the tunnel creation instruction instructing the access gateway to establish a transmission tunnel with the access device;
generating configuration information for instructing the access device to establish the transmission tunnel with the access gateway; and
transmitting the configuration information to the access device in response to a detection that the access device goes online, the configuration information causing the access device to establish the transmission tunnel with the access gateway, and causing the access device to access the private network based on the transmission tunnel.
